(19) United States
(12) Patent Application Publication
(10) Pub. No.: US 2012/0086263 A1
(43) Pub. Date: Apr. 12, 2012

(54) AUTOMOTIVE WHEEL

(75) Inventors: Yoshihiro Saito, Osaka (JP); Katsuhiro Nojima, Aichi (JP); Yoshihiro Kawaguchi, Aichi (JP); Toshihiko Kamikawa, Aichi (JP)

(73) Assignee: Central Motor Wheel Co., Ltd., Aichi (JP)

(21) Appl. No.: 13/376,254

(22) PCT Filed: Jun. 5, 2009
(86) PCT No.: PCT/JP2009/060325

§ 371 Date: Dec. 5, 2011

(51) Int. Cl. B60B 3/04

(52) U.S. Cl. 301/63.101

(57) ABSTRACT

An automotive wheel that can prevent deformation of a back side opening edge of a wheel rim in a radial direction and reduce the weight of the wheel rim is proposed.

Because the automotive wheel has a structure in which an annular rib section formed in a stepped manner at each of the inside and the outside and having a thinner wall thickness than the other part of a ledge section is circumferentially formed in the ledge section of the wheel rim, an effect of preventing the deformation of a back side opening edge of the wheel rim in a radial direction is improved by virtue of a shaping effect of the annular rib section, and a weight reduction effect can be provided in connection with the thinner wall thickness of the annular rib section.

### FIELD OF THE INVENTION

The present invention relates to an automotive wheel that includes a wheel disc connected to an axle and a wheel rim on which a tire is mounted.

### BACKGROUND

For example, the automotive wheel includes a so-called two-piece type wheel that is constructed by mating and welding an approximately cylindrical wheel rim and an approximately disc-shaped wheel disc. It is known that the wheel rim that constructs the two-piece type automotive wheel includes bead seat sections and flange sections that support beads of a tire on the front and the back sides, a drop section that dishes inwardly between the bead sections on the front and the back sides, and a ledge section that couples the back side bead seat section with the drop section.

The aforementioned wheel rim is required to have a relatively high strength for the bead seat sections and the flange sections on the front and the back side which support a tire; however, a strength required for the drop section or the ledge section is lower than that for the bead seat sections and the flange sections. In the case of an automotive steel wheel, the wheel rim is generally formed by shaping a rectangular steel plate into a cylindrical body and rolling the cylindrical body. Therefore, the steel plate that has an enough thickness so that the bead seat sections and the flange sections can obtain a desired strength is used for forming the wheel rim. Accordingly, the drop section and the ledge section have a strength that exceeds the required performance.

Recently, weight reduction of the automotive wheel is highly demanded, and the weight reduction of the wheel rim has been put into practice. In order to reduce the weight of the wheel rim, the structure has been proposed in Published Japanese Translation of PCT Application No. 2006-297465, for example, in which the thickness of the drop section or the ledge section that provides the strength greater than the required performance is decreased.

The aforementioned two-piece type automotive wheel is generally constructed through fitting and welding the wheel disc inside the drop section or the bead seat section of the wheel rim. This wheel rim supports the tire with the bead seat section and the flange section respectively formed in opening edges on the front and the back sides. When an automobile travels, the bead seat section and the flange section on the back side away from the welding part with the wheel disc tend to be deformed in a radial direction in comparison with those sections on the front side. Specifically, when the automobile makes a turn, the bead seat section and the flange section on the back side are more likely to be deformed. If a deformation amount in the radial direction increases, concerns arise that driving stability can be affected, and therefore it is required that the deformation be prevented as soon as possible.

However, when the thickness of the drop section or the ledge section is decreased as described above, the bead seat section and the flange section on the back side tend to be deformed in the radial direction. Thus, there has been a limit to the thickness reduction of the drop section or the ledge section.

The object of the present invention is to provide an automotive wheel that can prevent the bead seat section and the flange section on the back side of the wheel rim from deforming in the radial direction as well as can enhance a weight reduction effect of the wheel rim.

### SUMMARY OF THE INVENTION

The present invention is an automotive wheel including: bead seat sections that support a bead of a tire on front and back sides; a drop section that is provided between the bead seat sections on the front and the back sides and dishes inside; a wheel rim that includes the drop section and a ledge section that couples with the bead seat section on the back side; and a wheel disc that is connected to an axle, in which the wheel rim is provided with an annular rib section in the ledge section, which is dented from one side of an inside and an outside and protrudes to the other side, is circumferentially formed with a specified width so as to be in a stepped manner at each of the inside and the outside, and has a thinner wall thickness than the other part of the ledge section. Since the annular rib section is formed in a stepped manner with a specified width with respect to the other part of the ledge section, the annular rib section has a part that is generally parallel to the other part of the ledge section in a front-and-back side direction (hereinafter, referred to as a stepped peripheral section).

In such the structure, since the annular rib section in the stepped manner is circumferentially formed in the ledge section of the wheel rim, the rigidity of the ledge section improves, and thus the effect of preventing the deformation of the back side opening edge (the bead seat section and the flange section on the back side) in a radial direction which appears during the traveling of the automobile. Accordingly, when the structure is made such that the wall thickness of the annular rib section is decreased, a deformation amount of the back side opening edge in the radial direction can be reduced. In other words, the annular rib section can provide the effect of reducing the deformation amount of the back side opening edge in the radial direction by virtue of a shaping effect (effect by the stepped manner) as well as a weight reduction effect by virtue of the thin wall thickness. Therefore, while the deformation amount of the back side opening edge in the radial direction is reduced, the weight of the wheel rim can be reduced.

In this structure, the annular rib section preferably uses the structure where the width in the front-and-back side direction is within a range of 0.2 through 0.8 with respect to the width of the ledge section in the front-and-back side direction. As the width of the annular rib section in the front-and-back side direction is short, the weight reduction effect by virtue of the thin wall thickness is small, and as the width is long, the effect of preventing the deformation of the back side opening edge in the radial direction becomes small. Furthermore, the annular rib section preferably has a structure in which the width of the stepped peripheral section in the front-and-back side direction is formed three times or more than a level difference (height) protruding from the other part of the ledge section. Accordingly, the weight reduction effect by virtue of thin wall thickness as described above can be accomplished properly.

In the automotive wheel according to the present invention described above, the structure is proposed in which the annular rib section circumferentially formed in the ledge section of the wheel rim is formed in a stepped manner that is dented from the outside of the wheel rim and protrudes to the inside.

As an assembly work of the tire to the automotive wheel, a common method is that a back side bead of the tire is dropped into the drop section, and then air is filled into the tire, and therefore the back side bead is moved onto the back side bead seat section. In this structure, since the annular rib section does not protrude to the outside of the wheel rim, the annular rib section does not hinder the back side bead of the tire from moving during the assembly work of the tire. Therefore, workability of the tire assembly work can be maintained properly.

In addition, since the inner and the outer diameters of the annular rib section of this structure becomes smaller than those of the structure where the annular rib section is protruded to the outside in the ledge section, the weight reduction effect is improved.

Because the automotive wheel according to the present invention has a structure in which an annular rib section formed in a stepped manner at each of the inside and the outside and having a thinner wall thickness than the other part of a ledge section is circumferentially formed in the ledge section of the wheel rim as described above, an effect of preventing the deformation of a back side opening edge of the wheel rim in a radial direction is improved by virtue of a shaping effect of the annular rib section, and a weight reduction effect can be provided in connection with the thinner wall thickness of the annular rib section. Since the deformation of the back side opening edge in the radial direction is prevented by virtue of the shaping effect of the annular rib section, the weight reduction effect can be further improved in connection with the thinner wall thickness of the annular rib section. The automotive wheel according to the present invention provides an excellent driving stability through the effect of preventing the deformation of a back side opening edge of the wheel rim in a radial direction by virtue of the shaping effect of the annular rib section, and through the weight reduction of the wheel rim in connection with the thinner wall thickness of the annular rib section, when the automotive wheel is mounted to the automobile.

In the automotive wheel as described above, when the annular rib section has a structure formed in a stepped manner that is dented from the outside of the wheel rim and protrudes to the inside, the annular rib section does not hinder the assembly work of the tire, and the workability of the tire assembly work can be maintained properly. In addition, this structure has an improved weight reduction effect through smaller inner and outer diameters of the annular rib section in comparison with the structure where the annular rib section is protruded to the outside.

### BRIEF DESCRIPTION OF THE DRAWINGS

FIG. 1 is a vertical sectional view of the automotive wheel 1 according to an embodiment of the present invention.

FIG. 2 is an enlarged view of a part X of FIG. 1.

FIG. 3 is a partially enlarged view of a wheel rim according to another embodiment.

### DETAILED DESCRIPTION OF THE INVENTION

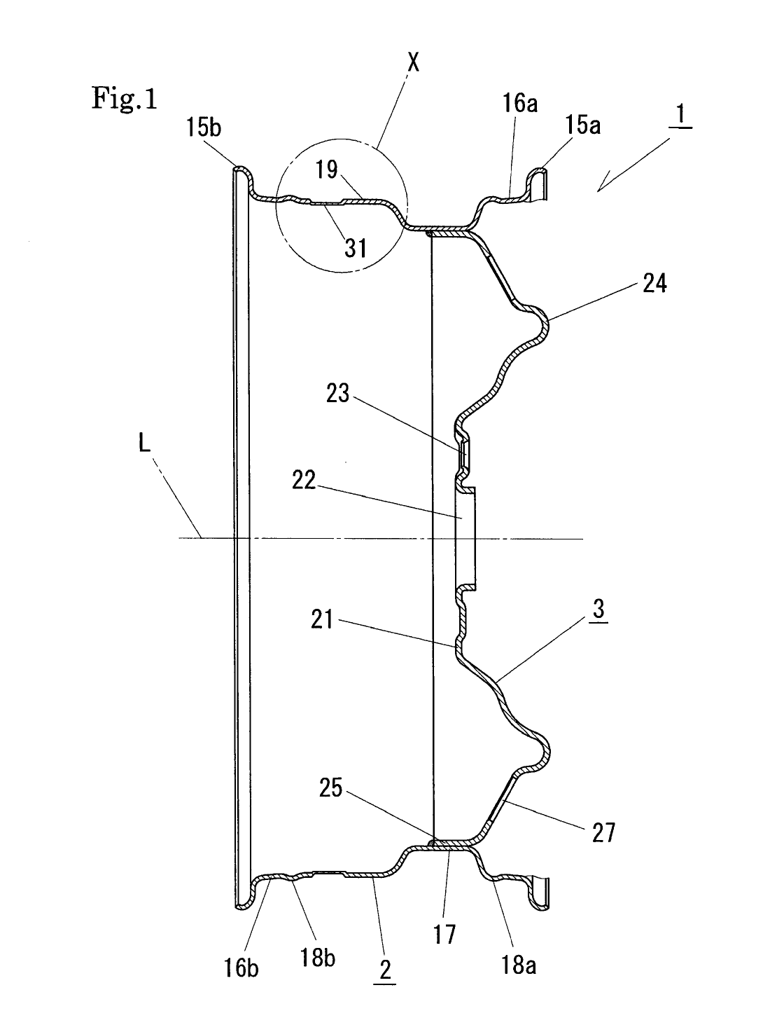

An embodiment of the present invention will be described in detail with reference to the accompanying drawings. FIG. 1 is a vertical sectional view of the automotive wheel 1 according to the present invention. The automotive wheel 1 has a so-called drop fitting type structure in which a disc flange section 25 of a wheel disc 3 is fitted inside a drop section 17 of a wheel rim 2, and the drop section 17 and the disc flange section 25 are fillet welded to be integrated. The wheel rim 2 and the wheel disc 3 are each obtained by shaping a steel plate. The automotive wheel 1 according to the embodiment of the present invention is a two-piece type steel wheel.

It should be noted that in the embodiment of the present invention, a direction toward an aesthetic surface side of the wheel disc 3 from its back side is designated as a front side direction, while a direction opposite to the front side direction is designated as a back side direction. Meanwhile, the direction toward the central axis L of the automotive wheel 1 along the radial direction of the wheel is designated as an inward direction, and the opposite direction is designated as an outward direction.

The wheel disc 3 described above is generally in the shape of a disc. The wheel disc 3 includes a generally circular hub mounting section 21 having a hub hole 22 opening in its center, and an annular hat section 24 protruding from the outer peripheral edge of the hub mounting section 21 to the front side. The hat section 24 has a plurality of ornamental holes 27 formed by drilling at equal intervals on the same circumference, and the annular disc flange section 25 is provided on an outer side of the hat section 24 so as to extend from the outer peripheral edge of the hat section 24 to the back side. In the hub mounting section 21, a plurality of bolt holes 23 each having a nut seat (not shown) are formed by drilling around the hub hole 22 at equal intervals on the same circumference. The hub mounting section 21, the hat section 24, and the disc flange section 25 are arranged concentrically with each other about the central axis L of the wheel disc 3.

The wheel disc 3 is formed by press work of the steel plate. More specifically, a generally square steel plate is formed into a saucer shape in which a circular dent is formed at the center, then the hub mounting section 21 and the hat section 24 are shaped by a drawing process, and the bolt holes 23 and the ornamental holes 27 are formed by a drilling process. Additionally, the saucer-shaped plate is subjected to restriking to form the disc flange section 25, thus to complete the forming of the wheel disc 3. These steps of forming the wheel disc 3 are performed in a well-known manner from related arts, and therefore the steps are not described any further.

The wheel rim 2 has a generally cylindrical shape, and is provided with the flange sections 15a and 15b and the bead seat sections 16a and 16b that support a bead of a tire (not shown) in the opening edges on the front and the back sides. The drop section 17 that dishes inside the wheel rim 2 is provided between the bead seat sections 16a and 16b on the front and the back sides, where the mounting of tire can be easily made by dropping the bead of the tire into the drop section 17 during the mounting of tire. The front side bead seat section 16a and the drop section 17 are coupled through a front side hump section 18a protruding outward in a curved manner. The ledge section 19 is provided to extend from the drop section 17 to the back side bead seat section 16b, and the ledge section 19 is coupled to the back side bead seat section 16b through a back side hump section 18b protruding outward in a curved manner. The front side and the back side hump sections 18a and 18b have a role in preventing the bead of the tire from being displaced from the front side and the back side bead seat sections 16a and 16b due to the load acting during the traveling of the automobile.

Here, the front side bead seat section 16a is the bead seat section 16a on the front side, and the back side bead seat section 16b is the bead seat section 16b on the back side. Similarly, the front side flange section 15a is the flange section 15a on the front side, and the back side flange section 15b is the flange section 15b on the back side.

The wheel rim 2 is obtained by shaping a rectangular steel plate with predetermined dimensions. More specifically, the rectangular steel plate is rolled with its shorter sides butting against each other, and the shorter sides are butt-joined by upset butt welding to be formed into a cylindrical body (not shown). The cylinder body is then subjected to rolling. In the rolling, specific inner and outer molds roll to press the cylinder body therebetween from the inside and the outside of the cylindrical body, thereby to form the cylinder body into the wheel rim 2 of a desired shape. A well-known manner from related arts can be applied to the method of forming the wheel rim 2, and therefore the method is not described any further.

A main part of the present invention is now described.

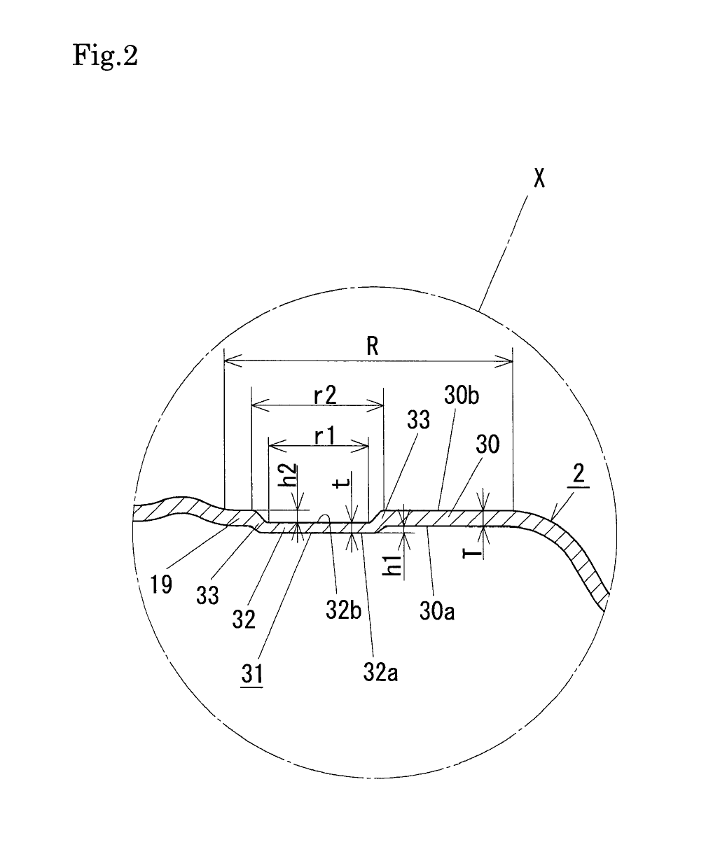

The aforementioned wheel rim 2 has an annular rib section 31 formed in the ledge section 19 along the circumferential direction of the wheel rim 2 as shown in FIGS. 1 and 2. The annular rib section 31 is formed to be dented from the outside of the wheel rim 2 and protrude inside the wheel rim 2, so as to be shaped in a stepped manner on an inner surface and an outer surface. In this embodiment, other parts of the ledge section 19 except the annular rib section 31 is designated as a ledge main section 30, and the annular rib section 31 and the ledge main section 30 constitute the ledge section 19.

The annular rib section 31 is shaped in the stepped manner with respect to the ledge main section 30 and formed with a stepped peripheral section 32 that is generally parallel to the ledge main section 30 and bending peripheral sections 33 and 33 that couple the font and the back side ends of the stepped peripheral section 32 with the ledge main section 30. An inner peripheral surface 32a of the stepped peripheral section 32 is arranged inside from an inner peripheral surface 30a of the ledge main section 30 to be formed in the stepped manner. Similarly, an outer peripheral surface 32b of the stepped peripheral section 32 is arranged inside from an outer peripheral surface 30b of the ledge main section 30 to be formed in the stepped manner.

A wall thickness t of the stepped peripheral section 32 of the annular rib section 31 is formed to be thinner than a wall thickness T of the ledge main section 30. Therefore, in the stepped peripheral section 32, a level difference h1 between the inner peripheral surface 32a of the stepped peripheral section 32 and the inner peripheral surface 30a of the ledge main section 30 is smaller than a level difference h2 between the outer peripheral surface 32b of the stepped peripheral section 32 and the outer peripheral surface 30b of the ledge main section 30.

Since the annular rib section 31 is formed in the ledge section 19 as described above, the rigidity of the ledge section 19 is improved. This is a result of forming the annular rib section 31 in the stepped manner. Furthermore, since the wall thickness of the stepped peripheral section 32 of the annular rib section 31 is thinner than the wall thickness of the ledge main section 30, the weight of the wheel is reduced. Since the rigidity of the wheel rim 2 of this embodiment is improved by virtue of a shaping effect of the annular rib section 31, the rigidity improvement effect by virtue of the shaping effect can complement the reduction of rigidity due to the thinner wall thickness of the stepped peripheral section 32. The effect of improving the rigidity as described above deteriorates with a decrease in wall thickness. Therefore, it is required that the shape of the annular rib section 31 in the stepped manner and the wall thickness t of the stepped peripheral section 32 be properly specified in order to provide desired rigidity.

The wheel rim 2 constructs the automotive wheel 1 through fitting the wheel disc 3 inside the drop section 17 and welding each other. In the automotive wheel 1, during the traveling of the automobile, the load acts on the bead seat sections 16a and 16b and the flange sections 15a and 15b on the front and the back sides which support the bead of the tire directly, and therefore the deformations appear in the radial direction. Particularly, the back side opening edge (the back side bead seat section 16b and the back side flange section 15b) is away from the drop section 17 in comparison with the front side opening edge (the front side bead seat section 16a and the front side flange section 15a), and thus the deformations tend to appear in the radial direction. In this embodiment, as described above, since the rigidity of the wheel rim 2 is improved by virtue of the shaping effect of the annular rib section 31, the effect of preventing the deformation in the radial direction is enhanced. Accordingly, even if the wall thickness of the stepped peripheral section 32 of the annular rib section 31 is formed to be thin, the deformation of the back side opening edge in the radial direction is prevented, and therefore both of the effect of preventing the deformation in the radial direction and the weight reduction effect can be provided.

In the automotive wheel 1 of this embodiment, the structure of the wheel rim 2 that meets the following conditions can further properly provide a function effect of the present invention described above.

t<T (1)

r1>h1×3 (2)

As shown in FIG. 2, t is the wall thickness of the stepped peripheral section 32, and T is the wall thickness of the ledge main section 30. In addition, r1 is a width of the stepped peripheral section 32 in a front-and-back side direction, and h1 is the level difference of the annular rib section 31 on a protruding side. The above condition (2) is determined as a condition that can properly produce the weight reduction effect if the condition is met. Under the condition (1), the rigidity is reduced as the wall thickness t of the stepped peripheral section 32 becomes thinner, and therefore the structure preferably has the wall thickness t of 0.4 through 0.8 with respect to the wall thickness T of the ledge main section 30.

Furthermore, as a constructing condition of the wheel rim 2, it is preferable that the structure meet the following conditions.

0.2×R<r2<0.8×R (3)

0.5×r2<r1<0.9×r2 (4)

R is a width of the ledge section 19 in a front-and-back side direction, and r2 is a width of the annular rib section 31 in a front-and-back side direction. The conditions (3) and (4) are determined to provide both the rigidity improvement by virtue of the aforementioned shaping effect and the weight reduction effect by virtue of thin wall thickness in a balanced manner by specifying width r1 and r2 of the annular rib section 31 and the stepped peripheral section 32 in the front-and-back side direction with respect to the width R of the ledge section 19 in the front-and-back side direction. Under the condition (3), the structure further preferably has the width r2 of the annular rib section 31 of 0.3 through 0.6 with respect to the width R of the ledge section 19. Accordingly, the rigidity improvement effect and the weight reduction effect can be provided in a well-balanced manner.

As a manufacturing method of forming the wheel rim 2 of this embodiment, a rectangular steel plate that has a shorter side dimension can be used in comparison with the case where the wheel rim of the same size is formed. More specifically, when the cylindrical body is formed from the steel plate and then the cylindrical body is rolled, decreasing the wall thickness of the annular rib section 31 allows the width of the cylindrical body to be extended in the direction of the central axis L. Therefore, the wheel rim can be formed with a steel plate that has a shorter side dimension in comparison with the wheel rim in which the annular rib section is not formed, and material cost can be reduced.

Furthermore, the automotive wheel 1 of this embodiment was actually mounted to an automobile, and evaluation through actual driving was conducted. A 15 inch wheel was used for the automotive wheel 1. Dimensions of the main parts of the wheel rim 2 were: 2.6 mm for the wall thickness T of the ledge main section 30; 1.6 mm for the wall thickness t of the annular rib section 31; 1 mm for the aforementioned level difference h1; 2 mm for the level difference h2; 21 mm for the width r2 of the annular rib section 31; 15 mm for the width r1 of the stepped peripheral section 32; and 37 mm for the width R of the ledge section 19. The evaluations were conducted on a conventional structure that does not have the annular rib section and a comparative structure in which a part of the ledge section was dented from the outside, and comparison with these structures was also conducted. The comparative structure has an inner peripheral surface of the ledge section which does not protrude but has a smooth surface, and the width in the front-and-back side direction of the dented part is the same as the width r1 of the stepped peripheral section 32 of the annular rib section 31 according to this embodiment. The dimensions of the conventional structure and the comparative structure are all the same, except the dimension of the annular rib section 31. On the automotive wheel 1 according to this embodiment, an automotive wheel of the conventional structure (not shown), and an automotive wheel of the comparative structure (not shown), the same tire was mounted, a test was conducted to determine the maximum deformation amount of each back side opening edge (back side flange section) in a radial direction during the traveling of the automobile. As a result, the automotive wheel 1 according to this embodiment had the maximum deformation amount that was slightly larger than the conventional structure; however, it was within an acceptable level. In contrast, it was confirmed that the maximum deformation amount was sufficiently small in comparison with the comparative structure. Furthermore, as a result of measurement of the weight of each automotive wheel, the weight of the automotive wheel 1 according to this embodiment was lighter than that of the conventional structure and approximately the same as that of the comparative structure. From the results described above, the automotive wheel 1 according to this embodiment can prevent the deformation of the back side opening edge of the wheel rim 2 while reducing the weight.

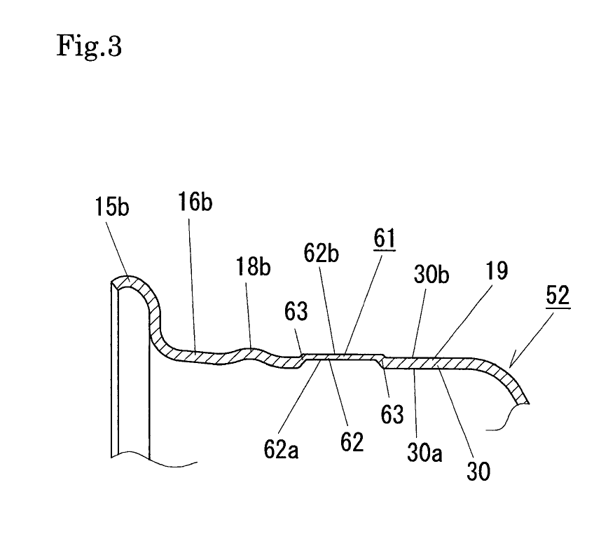

In contrast, another embodiment according to the present invention is shown in FIG. 3. The wheel rim 52 includes an annular rib section 61 in the ledge section 19 in the stepped manner which dented from the inside and protrudes to the outside. The annular rib section 61 is formed with a stepped peripheral section 62 that is generally parallel to the ledge section 19 and bending peripheral sections 63 and 63 that couple with the ledge section 19 on the both side of the stepped peripheral section 62. An outer peripheral surface 62b of the stepped peripheral section 62 is arranged outside from the outer peripheral surface 30b of the ledge main section 30, and an inner peripheral surface 62a of the stepped peripheral section 62 is arranged outside from the inner peripheral surface 30a of the ledge main section 30. The level difference (not shown) between the outer peripheral surface 62b of the stepped peripheral section 62 and the outer peripheral surface 30b of the ledge main section 30 is smaller than the level difference (not shown) between the inner peripheral surface 62a of the stepped peripheral section 62 and the inner peripheral surface 30a of the ledge main section 30. The wall thickness of the stepped peripheral section 62 is thinner than the wall thickness of the ledge main section 30. The another embodiment has the same structure as the aforementioned embodiment, except the structure where the annular rib section 61 protrudes outside, and therefore the same reference numerals and symbols denote the same components, and the description of the same components is not repeated. The structure including the annular rib section 61 that protrudes outside as described above can, as the aforementioned embodiment, improve the rigidity by virtue of the shaping effect of the annular rib section 61, and reduce the weight by virtue of the thinner wall thickness of the stepped peripheral section 62. Therefore, the automotive wheel (not shown) including the wheel rim 52 can prevent the deformation of the back side opening edge in the radial direction which appears during the traveling of the automobile and reduce the weight.

As in the aforementioned another embodiment, the structure including the annular rib section that protrudes outside may be made such that the annular rib section is formed from a back side end of the ledge section and a hump section is not included. In this case, the annular rib section can prevent the bead of the tire that is supported on the back side bead seat section from displacing. The annular rib section provides a function effect of the hump section. In the structure where the annular rib section protrudes outside (as the aforementioned another embodiment), inner and outer diameters of the annular rib section become larger than those in the aforementioned embodiment, and thus the weight reduction effect becomes smaller. However, if the structure is made such that the hump section is not included as described above, the weight reduction effect can be improved, and therefore sufficient weight reduction can be accomplished.

The present invention is not limited to the embodiments discussed above, and may be modified appropriately within the scope and spirit of the present invention. For example, other than steel plate, a structure that is formed from an aluminum-alloy plate or a magnesium-alloy plate can provide the same function effect. Furthermore, the present invention can be applied to not only the two-piece type automotive wheel as described above but also one-piece type or three-piece type automotive wheels and can provide the same function effect.

### Description of Reference Numerals

1: automotive wheel

2, 52: wheel rim

3: wheel disc

15a: front side flange section

15b: back side flange section

16a: front side bead seat section

16b: back side bead seat section

17: drop section

19: ledge section

30: ledge main section (part of ledge section except annular rib section)

31, 61: annular rib section

What is claimed is:

1. An automotive wheel comprising: bead seat sections that support a bead of a tire on front and back sides; a drop section that is provided between the bead seat sections on the front and the back sides and dishes inside; a wheel rim that includes the drop section and a ledge section that couples with the bead seat section on the back side; and a wheel disc that is connected to an axle,
wherein the wheel rim is provided with an annular rib section in the ledge section, which is dented from one side of an inside and an outside and protrudes to the other side, is circumferentially formed with a specified width so as to be in a stepped manner at each of the inside and the outside, and has a thinner wall thickness than the other part of the ledge section.

2. The automotive wheel according to claim 1, wherein the annular rib section circumferentially formed in the ledge section of the wheel rim is formed in a stepped manner that is dented from the outside of the wheel rim and protrudes to the inside.
